(19) United States
(12) Patent Application Publication
(10) Pub. No.: US 2007/0053276 A1
(43) Pub. Date: Mar. 8, 2007

(54) Optics for double-sided media

(76) Inventors: D. Mitchel Hanks, Ft. Collins, CO (US); Kevin L. Colburn, Greeley, CO (US); Cameron Hutchings, Meridian, ID (US); D. Travis Lay, Horseshoe Bend, ID (US); Curtis Reese, Boise, ID (US); Lawrence Nathaniel Taugher, Loveland, CO (US); Philip M. Walker, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/222,348

(22) Filed: Sep. 8, 2005

(51) Int. Cl. G11B 7/135

(52) U.S. Cl. 369/112.29

(57) ABSTRACT

An optical system for writing on a double-sided medium is disclosed. A beam source is configured to generate a light beam in a first direction relative to a first side of the medium. A steering mechanism is able to direct the light beam in a second direction substantially along the first side, such that the light beam is configured to impinge on a first reflector. The first reflector is able to reflect the light beam in a third direction, such that the light beam is routed outside a substantially opaque annulus of the medium, and is configured to impinge on a second reflector. The second reflector is able to reflect the light beam in a fourth direction substantially opposite the second direction, such that the light beam is configured to impinge on a third reflector. The third reflector is able to reflect the light beam in a fifth direction substantially toward a second side of the medium opposite the first side, such that the light beam strikes the second side of the medium.

### BACKGROUND

Optical disk writing devices, such as compact disk (CD) drives, digital versatile disk (DVD) drives, and the like, may be used not only to write data, but also to inscribe visible text or graphics on a surface of a disk. This ability has made the process of labeling disks easier for many users than the previous process of generating a paper label and adhering it to the non-data surface of the disk, or handwriting on the surface of the disk with a permanent marker. However, the process generally requires user intervention to manually flip the disk over to inscribe the visible text or graphics on the non-data side. That is, one method available is to eject the disk from the drive, manually remove the disk from its holder, flip the disk over, and replace it in the drive so that the laser is positioned for burning the label information on the non-data surface of the disk. In similar fashion, a process for manually flipping the disk is often necessary when using an optical drive to read or write data on a double-sided optical disk; that is, an optical disk having data storage capability on both sides.

Complex mechanisms have been developed for automatically flipping optical disks, thereby relieving a human user of an inconvenient and time-consuming task. Such mechanisms may, for example, resemble the cumbersome flipping mechanisms of conventional jukeboxes for playing double-sided vinyl records. In some approaches to the problem, motorized mechanisms have been developed for moving an optical pickup unit (OPU) from one side of the disk to the other substantially along a U-shaped track.

Another solution for using both sides of an optical disk is to use two optical pickup units, positioning one on each side of the disk, so as to avoid having to flip the disk. The addition of a second OPU, however, adds cost and complexity.

### BRIEF DESCRIPTION OF THE DRAWINGS

The accompanying drawings illustrate embodiments of the invention and together with the description serve to explain the principles of the invention; it being understood, however, that this invention is not limited to the precise arrangements and instrumentalities shown. Rather, the accompanying drawings are included to provide a further understanding of the invention.

FIG. 1 is a diagram illustrating common components of an exemplary data storage device, according to an embodiment of the invention.

FIG. 2A is a side view of a first exemplary data storage device, according to an embodiment of the invention.

FIG. 2B is an axial view of the first exemplary data storage device, according to an embodiment of the invention.

FIG. 3A is a side view of a second exemplary data storage device, according to an embodiment of the invention.

FIG. 3B is a side view of the second exemplary data storage device showing rotation of an optical pickup unit, according to an embodiment of the invention.

FIG. 4A is a side view of a third exemplary data storage device, according to an embodiment of the invention.

FIG. 4B is a side view of the third exemplary data storage device showing interposition of a reflector, according to an embodiment of the invention.

FIG. 5A is an axial view from a first side of a fourth exemplary data storage device according to an embodiment of the invention.

FIG. 5B is a side view of the fourth exemplary data storage device according to an embodiment of the invention.

FIG. 5C is an axial view from a second side of a fourth exemplary data storage device according to an embodiment of the invention.

FIG. 6A is an axial view of a fifth exemplary data storage device according to an embodiment of the invention.

FIG. 6B is a side view of an exemplary data storage device according to an embodiment of the invention.

FIG. 6C is a side view of an exemplary data storage device according to an embodiment of the invention.

FIG. 6D is a side view of an exemplary data storage device according to an embodiment of the invention.

FIG. 7 shows an exemplary method for writing on a double-sided medium according to an embodiment of the invention.

### DETAILED DESCRIPTION

Reading and writing to both surfaces of a medium such as an optical disk, without the manual step of flipping over the disk, may be accomplished by introducing a plurality of mirrors (such as a moveable mirror as well as a series of static mirrors), to deflect the optical beam from the bottom side to the top surface of the disk. Components of the system, in some embodiments of this invention, may be housed, if desired, in a case that is the same size as that of a standard data storage device.

Example of Data Storage Drive

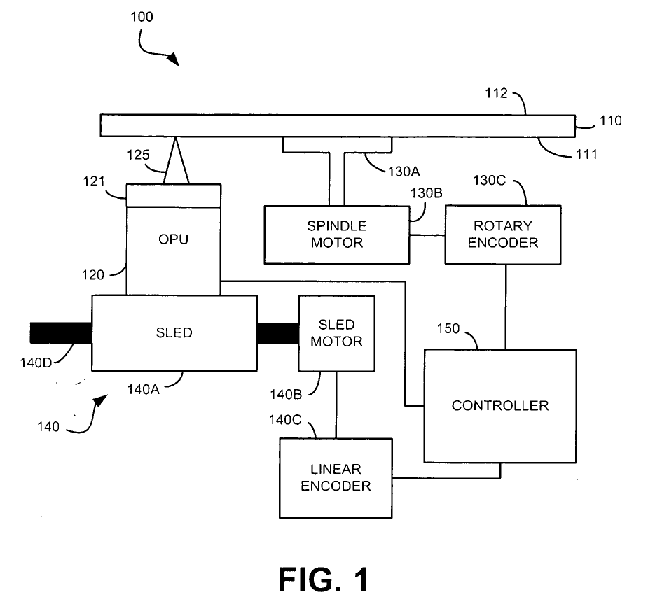

Referring to the drawings, in which like reference numerals indicate like elements, FIG. 1 is a diagram illustrating common components of an exemplary data storage device 100 according to an embodiment of the invention. The device 100 is for writing data to the disk 110, and may also be able to read data from the disk 110. The device 100 may be adapted to provide labeling capabilities for writing visible text or graphics on a surface of disk 110. The device 100 may, for example, be part of a data storage device, which in turn is connectable to a computer via an I/O channel.

More specifically, in an illustrative embodiment, the device 100 is a data storage device for writing to, and in some embodiments reading from, an optically writable first side 111 of an optical disk 110. The data storage device 100 includes an optical pickup unit (OPU) 120 able to mark the first side 111 with an optical beam 125 such as a laser beam. The OPU 120 comprises a beam source 121 and, in some embodiments, an objective lens (not shown) for focusing the optical beam 125 onto the first side 111. The optical disk 110 also has a second side 112 opposite the first side 111. Embodiments of the invention permit the optical beam 125 to be focused onto the second side 112 of the optical disk 110.

The first side 111 of the disk 110 is the substantially planar surface of the disk 110 generally closest to the OPU 120, and the second side 112 is the opposite substantially planar surface of the disk 110. In some embodiments, one side of the disk 110 is adapted for receiving human-visible label information; such a side may be referred to as a “label side” or “non-data side” of the disk 110. In a typical embodiment, when the disk 110 is inserted in the drive 100, the disk 110 is oriented so that the label side of the disk 110 is the second side 112.

The device 100 also includes a spindle 130A, a spindle motor 130B, and a rotary encoder 130C, which are collectively referred to as the spindle motor mechanism 130. In some embodiments, spindle 130A includes or is connected to a platen (not shown) for gripping the disk 110. The device 100 further includes a sled 140A, a sled motor 140B, a linear encoder 140C, and one or more rails 140D, which are collectively referred to as the sled motor mechanism 140. Finally, the device 100 includes a controller 150.

The spindle motor mechanism 130 rotates the disk 110. In particular, the disk 110 may be situated on the spindle 130A, which is rotated or moved by the spindle motor 130B to a given position specified by the rotary encoder 130C communicatively coupled to the spindle motor 130B. The sled motor mechanism 140 moves the OPU 120 substantially radially relative to the disk 110. In particular, the OPU 120 is situated on the sled 140A, which is moved on the rails 140D by the sled motor 140B to a given position specified by the linear encoder 140C communicatively coupled to the sled motor 140B. The rotary encoder 130C and the linear encoder 140C may include hardware, software, or a combination of hardware and software.

The controller 150 controls the spindle motor mechanism 206 and the sled motor mechanism 140. By controlling the motor mechanisms 130, 140, the controller 150 is able to advance the OPU 120 to desired positions on tracks of the disk 110 (such as one or more spiral or concentric tracks). The controller 150 similarly is able to cause the OPU 120 to pass over the tracks, and to advance the OPU 120 from one track to another track. The device 100 may comprise firmware or other computer-readable media for storing instructions to the controller 150.

As will be appreciated by those of ordinary skill in the art, the components depicted in the device 100 are representative of an illustrative embodiment of the invention, and do not limit all embodiments of the invention.

### First Exemplary Embodiment

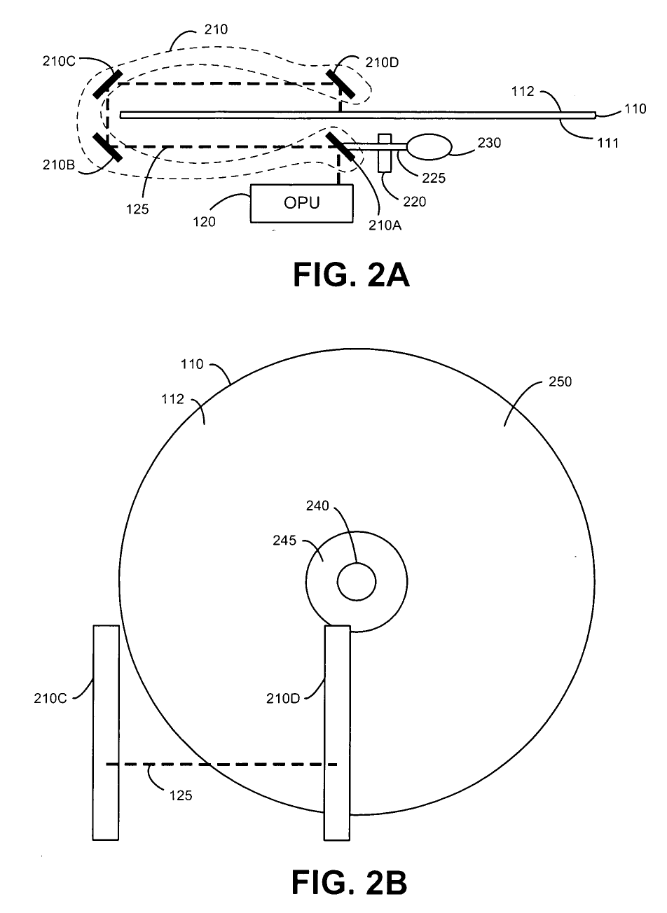

FIG. 2A is a side view of a first exemplary data storage device 100 according to an embodiment of the invention. A movable reflector 210A and a plurality of statically positioned reflectors 210B, 210C, 210D (collectively, reflectors 210) enable the use of a single optical beam 125 to write to (or read from) both the first side 111 and the second side 112 of disk 110. The reflectors 210 may be used to route the optical beam 125 substantially along (in general “substantially along” will be substantially parallel to) the first side 111 of the disk 110, around the edge of disk 110, and substantially along the second side 112, to a position where the beam 125 is reflected to the surface of the second side 112 by reflector 210D.

A steering mechanism 220 may comprise a mechanism mover such as a motor, stepper motor, solenoid, magnetic catch, or the like, controlled by controller 150. The steering mechanism 220 allows an objective lens 230, if used, to be rotated or moved into and out of the path of the beam 125, and allows movable reflector 210A to be rotated or moved into and out of the path of the beam 125. In some embodiments, the steering mechanism 220 and objective lens 230 may be included in or connected to the OPU 120, or may be attached to or situated upon sled 140A.

In an exemplary embodiment, the steering mechanism 220 is able to rotate a supporting arm 225, such as around an axis substantially alongside (in general “substantially alongside” will be substantially parallel to) the axis around which disk 110 rotates. The steering mechanism 220 may be controlled by controller 150. A first end of the supporting arm 225 supports the objective lens 230, and a second end of the supporting arm 225 supports the reflector 210A. In a further embodiment, a first supporting arm 225 supports the objective lens 230, and a second supporting arm 225 supports the reflector 210A. Reflectors 210 are arranged such that, when reflector 210A is in the path of the beam 125, the substantially collimated beam 125 converges at a focal point on the surface of second side 112 of the disk 110.

FIG. 2B is an axial view of the first exemplary data storage device 100 according to an embodiment of the invention, looking downward upon the second side 112 of the disk 110. The disk 110 may have a hub 240, defining the boundary of a hole in the disk 110. The spindle motor mechanism 130 is able to rotate the disk 110 around an axis substantially central to the hub 240. The hub 240 may in some embodiments be encircled by a translucent or transparent region of the disk 110 where no data may be stored, such as non-opaque annulus 245.

A substantially opaque annulus 250 of the disk 110 includes the portion of the disk 110 outside of the hub 240 and outside of the non-opaque annulus 245. The substantially opaque annulus 250 may extend in some embodiments to the outer circumference of the disk 110; however, in further embodiments, a second non-opaque annulus (not shown) may encircle the substantially opaque annulus 250 proximate to the outer circumference of disk 110.

The reflectors 210 do not rotate together with the disk 110. Reflectors 210B, 210C, 210D may be statically mounted or positioned in relation to one another. When movable reflector 210A is positioned in the path of beam 125 suitably for reading or writing on the second side 112, movable reflector 210A is also positioned relative to the static reflectors 210B, 210C, 210D to reflect the beam 125 to the second side 112. In some embodiments, the statically positioned reflectors 210B, 210C, 210D may be mounted on a framework or case supporting or enclosing drive 110.

For writing on the first side 111, the OPU 120 typically produces a light beam 125 having a high numeric aperture, focused by the objective lens 230 a short distance away from the OPU 120, such as on the surface of first side 111. However, in order to use the beam 125 for reading or writing on the second side 112, it is generally desirable to replace, modify, or supplement the objective lens 230 so that the beam 125 is collimated or lensed such that it has a longer focal length, thereby allowing the beam 125 to be routed around to the second side 112 without suffering significant divergence.

The beam may be brought from the first side 111 to the second side 112 by a variety of means. In the exemplary embodiment, as illustrated, the reflectors 210 are at angles of about forty-five degrees to the surfaces of the first side 111 and the second side 112. When the second side 112 is to be written or read, the focusing lens 230 is moved out of the way of the beam 125, and a forty-five degree reflector 210A is moved into the path of the beam 125. Reflector 210A is generally smaller and shorter in length than reflectors 210B, 210C, 210D that may be statically positioned, such that reflector 210A may be readily maneuvered by steering mechanism 220 within the available space.

Reflector 210A directs the optical beam 125 substantially along the first side 111 of the disk 110, to reflector 210B beyond the edge of the disk 110. Reflector 210B may be a bar reflector that runs substantially along the axis of rails 140D along which sled 140A moves. Reflector 210B is mounted such that reflector 210B directs the beam 125 around the edge of disk 110, to reflector 210C. A bar reflector may be used so that as the sled 140A moves the OPU 120 substantially radially with respect to the disk 110, the beam 125 will still impinge on the reflector 210B and be routed outside the edge of disk 110.

Once the beam 125 has reached a height above the surface of second side 112 of the disk 110, the beam 125 may impinge on another bar reflector 210C, which routes the beam 125 across the surface of the second side 112. The path of beam 125 continues above the second side 112 substantially alongside the path of outgoing beam 125 between reflectors 210A and 210B, but on the opposite side of the disk 110. The beam 125 then may impinge on another bar reflector 210D that directs the beam 125 substantially toward (in general “toward” will be perpendicular to) the surface of the second side 112, and thereafter the beam 125 strikes the surface of the second side 112. The entire path length of beam 125 is generally a little more than the full diameter of the disk 110, since the path runs approximately two half disk diameters (segments of beam 125 from 210A to 210B, and from 210C to 210D) plus additional short path segments to the surfaces of the disk 110. In some embodiments, the beam 125 is able to be focused at a focal length of approximately the diameter of disk 110, so as to be focused proximate to the surface of second side 112. In further embodiments, the beam 125 is able to be focused at a focal length of at least the diameter of disk 110, so as to be focused at or proximate to the surface of second side 112.

In some embodiments, reflectors 210B, 210C, 210D (such as bar reflectors) may be statically arranged such that the position where the beam 125 strikes the surface of the second side 112 tracks the radial motion of the OPU 120 proximate to the first side 111. It may also be desirable to include means for positioning the beam 125 more precisely once the beam 125 is adjacent to the second side 112. In such embodiments, for example, a mechanical coupling may move reflector 210D, or may move an additional mirror or lens (not shown), to redirect the beam 125 as the sled 140A moves substantially along the first side 111.

In an embodiment directed to label printing (e.g., inscribing visible text or graphics) on the second side 112, there are generally relaxed spot size requirements on the second side 112. That is, it is often desirable for a spot of light where the beam 125 strikes the second side 112 for label printing to be larger (i.e., a more diffused spot) than a spot of light where the beam 125 strikes the first side 112 for reading or writing digital data (i.e., a more focused spot). Accordingly, rather than employ a second focusing lens near the surface of the second side 112, optics of the OPU 120 and objective lens 230 may be such that a focal point of the beam 125 is at the surface of the second side 112. For example, a long focal length lens may be employed in the OPU 120, so that the beam 125 can be focused before being routed outside and over the disk 110. This is possible because label inscription on the second side 112 generally requires neither high spot quality nor the small spot size that necessitates a short focal length. In an illustrative example, with a focal point 124 mm away from the source of the beam 125, the numerical aperture of the objective lens 230 may be on the order of 0.016, which would result in a spot full-width-half-max size of 29 μm for a 780 nm beam and 24 μm for a 650 nm beam, either of which works suitably well for label printing.

In other embodiments, such as for reading or writing digital data on second side 112, it may be desirable for the beam 125 being routed to the second side 112 to be collimated as it goes around the disk 110 and across the second side 112, and to be focused shortly before the beam 125 reaches the surface of the second side 112. In such embodiments, a focusing lens (not shown), such as a second objective lens 230, may be introduced into the path of beam 125, such as between reflector 210D and second side 112. In some embodiments, the second objective lens 230 may be statically positioned in the path of beam 125; however, if a minimal spot size is desired for writing digital data to the second side 112, such as for a CD or DVD data surface, then the second objective lens 230 may be actively servoed to maintain a desired focus. If the second side 112 is adapted for labeling applications, the second objective lens 230 may be placed an appropriate distance from the second side 112 in order to provide a longer focal length suitable for relaxed focusing requirements.

In a further embodiment, in order to maximize the light power of the beam 125 reaching the second side 112 surface, the optics of OPU 120 and the objective lens 230 may be designed such that truncation of the light power for spot size minimization occurs at the objective lens 230; thus, when the objective lens 230 is moved aside, more light from beam 125 may be allowed to travel to the second side 112 surface.

In the exemplary embodiment illustrated in FIG. 2A and FIG. 2B, the beam 125 is routed outward around the side of disk 110, passing around the substantially opaque annulus 250, and outside the circumference of disk 110. However, in other embodiments, using alternate arrangements of reflectors 210, the beam 125 may be routed through the non-opaque annulus 245 near the hub 240, or the beam 125 may be routed through the hub 240 (such as through a hole in the spindle 130A or spindle motor 130B).

### Second Exemplary Embodiment

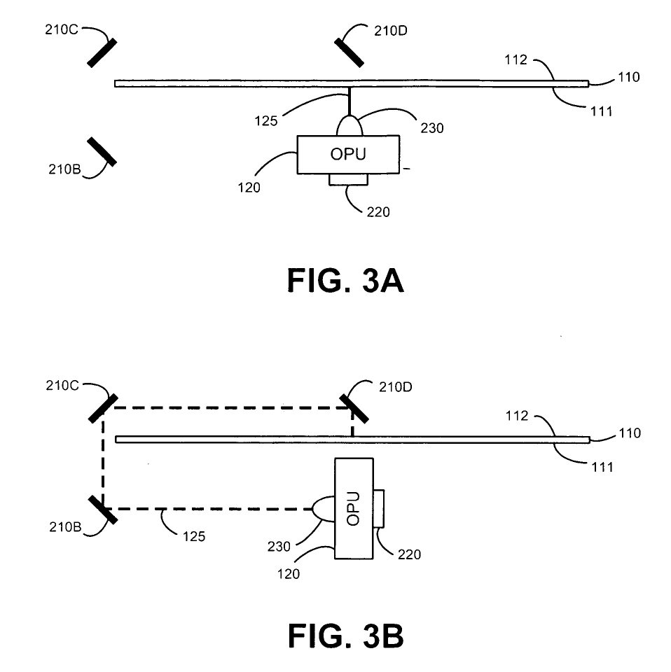

FIG. 3A and FIG. 3B are side views of a second exemplary data storage device 100 according to an embodiment of the invention. Reflectors 210B, 210C, 210D (collectively, reflectors 210) may be statically positioned so as to enable the use of a single optical beam 125 to write to (or read from) both the first side 111 and the second side 112 of disk 110, as more fully described with respect to FIG. 2A and FIG. 2B.

In the exemplary embodiment, OPU 120 includes an objective lens 230 and a beam source 121 (such as a laser) for generating beam 125. OPU 120 is connected to a steering mechanism 220, such as a rotating mechanism for rotating the OPU 120, thereby allowing the beam 125 to be directed substantially toward the first side 111 as shown in FIG. 3A, or substantially toward the reflector 210B as shown in FIG. 3B. OPU 120 and steering mechanism 220 may, for example, be attached to sled 140A (shown in FIG. 1), for moving the OPU 120 back and forth in a direction radial to the disk 110 and substantially along the substantially planar surface of first side 111.

Steering mechanism 220 is able to cause the OPU 120 to rotate ninety degrees, thereby directing the beam 125 from a path substantially toward first side 111 (as shown in FIG. 3A) to a path substantially along first side 111 (as shown in FIG. 3B), and vice versa. In an exemplary embodiment, steering mechanism 220 comprises a mechanism mover, such as a motor and a quarter circle spur gear. In further exemplary embodiments, steering mechanism 220 may comprise a mechanism mover such as a stepper motor, solenoid, magnetic catch, or the like, for rotating the OPU 120.

As illustrated in FIG. 3A and FIG. 3B, the reflectors 210 may be at angles of about forty-five degrees to the surfaces of the first side 111 and the second side 112. When the second side 112 is to be written or read, the OPU 120 may be rotated by steering mechanism 220, to direct the beam 125 to a path substantially along first side 111, as shown in FIG. 3B. The beam 125 then impinges on reflector 210B. Reflector 210B is mounted such that reflector 210B directs the beam 125 around the edge of disk 110, to reflector 210C. A bar reflector may be used for reflector 210B so that as the sled 140A moves the OPU 120 substantially radially with respect to the disk 110, the beam 125 will still impinge on the reflector 210B and be routed substantially toward the surface of first side 111, around the edge of disk 110.

Once the beam 125 has reached a height above the surface of second side 112 of the disk 110, the beam 125 impinges on another bar reflector 210C, which routes the beam 125 across the surface of the second side 112. The path of beam 125 continues above the second side 112 substantially alongside the path of outgoing beam 125 between reflectors 210A and 210B, but on the opposite side of the disk 110. The beam 125 then impinges on another bar reflector 210D that directs the beam 125 substantially toward the surface of the second side 112, and thereafter the beam 125 strikes the surface of the second side 112.

When the beam 125 is routed to the second side 112, the beam 125 should either be of long focal length or collimated; otherwise, the beam 125 will substantially diverge, which is generally not desired. In the illustrated embodiment, the objective lens 230 shown in FIG. 3A may be a first lens 230 having a short focal length suitable for focusing the beam 125 on the first side 111, and the objective lens 230 shown in FIG. 3B may be a second lens 230 having a long focal length suitable for focusing the beam 125 on the second side 112. In other embodiments, OPU 120 may be able to move the objective lens 230 shown in FIG. 3B out of the path of beam 125 when the beam 125 is routed to second side 112.

### Third Exemplary Embodiment

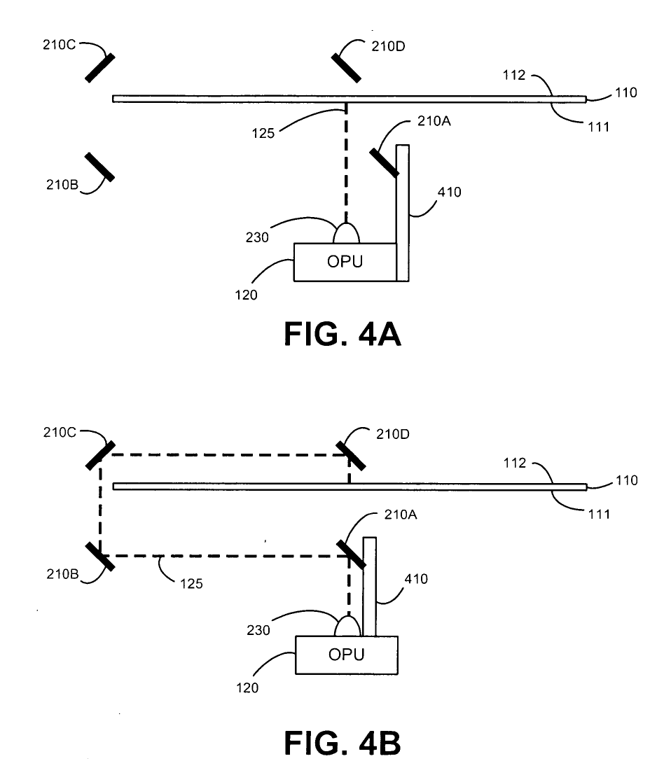

FIG. 4A and FIG. 4B are side views of a third exemplary data storage device 100 according to an embodiment of the invention. Reflectors 210B, 210C, 210D (collectively, reflectors 210) may be statically positioned so as to enable the use of a single optical beam 125 to write to (or read from) both the first side 111 and the second side 112 of disk 110, as more fully described with respect to FIG. 2A and FIG. 2B.

In the exemplary embodiment, OPU 120 includes an objective lens 230 and a beam source 121 (such as a laser) for generating beam 125. A steering mechanism 410, such as an optical motor mechanism (which may, for example, include one or more solenoids, galvanometers, or the like) is able to move a reflector 210A (e.g., arranged at forty-five degrees) out of the path of the beam 125 (shown in FIG. 4A) when the first side 111 is to be written or read. In some embodiments, the steering mechanism 410 is also able to move the reflector 210A into the path of the beam 125 (shown in FIG. 4B) when the second side 112 is to be written or read. In other embodiments, the reflector 210A is statically positioned, and the steering mechanism 410 is able to move the OPU 120 for directing the beam 125 to reflector 210A when the second side 112 is to be written or read, Reflector 210A is generally smaller and shorter in length than reflectors 210B, 210C, 210D, such that reflector 210A may be readily maneuvered by steering mechanism 410 within the available space. The steering mechanism 410 may, for example, be attached to OPU 120 or situated upon the sled 140A (shown in FIG. 1), and may be controlled by controller 150 (shown in FIG. 1).

When the second side 112 is to be written or read, reflector 210A directs the optical beam 125 substantially along the first side 111 of the disk 110, to impinge on reflector 210B beyond the edge of the disk 110. Reflector 210B is mounted such that reflector 210B directs the beam 125 around the edge of disk 110, to reflector 210C. A bar reflector may be used for reflector 210B so that as the sled 140A moves the OPU 120 substantially radially with respect to the disk 110, the beam 125 will still impinge on the reflector 210B and be routed around the edge of disk 110.

Once the beam 125 has reached a height above the surface of second side 112 of the disk 110, the beam 125 may impinge on another bar reflector 210C, which routes the beam 125 across the surface of the second side 112. The path of beam 125 continues above the second side 112 substantially alongside the path of outgoing beam 125 between reflectors 210A and 210B, but on the opposite side of the disk 110. The beam 125 then may impinge on another bar reflector 210D that directs the beam 125 substantially toward the surface of the second side 112, and thereafter the beam 125 strikes the surface of the second side 112.

When the beam 125 is routed to the second side 112, the beam 125 should either be of long focal length or collimated; otherwise, the beam 125 will substantially diverge, which is generally not desired. In the illustrated embodiment, the objective lens 230 shown in FIG. 4A may be a first lens 230 having a short focal length suitable for focusing the beam 125 on the first side 111, and the objective lens 230 shown in FIG. 4B may be a second lens 230 having a long focal length suitable for focusing the beam 125 on the second side 112. In other embodiments, OPU 120 may be able to move the objective lens 230 shown in FIG. 4B out of the path of beam 125 when the beam 125 is routed to second side 112.

### Fourth Exemplary Embodiment

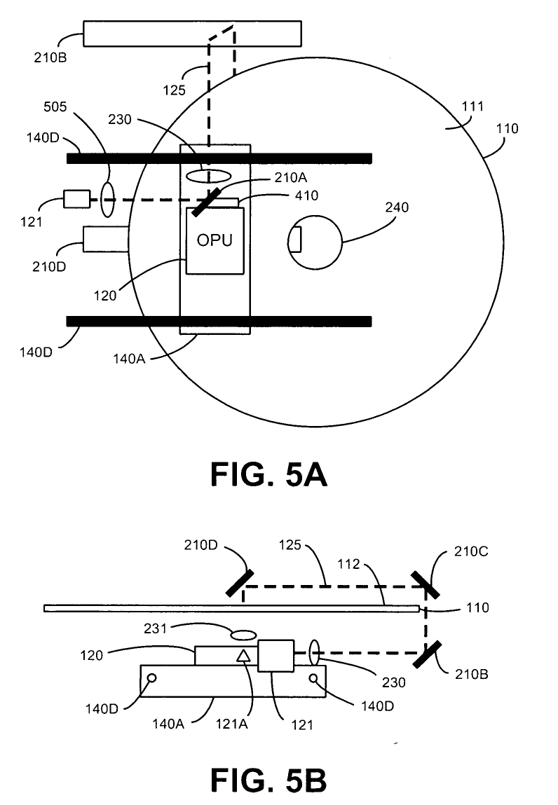

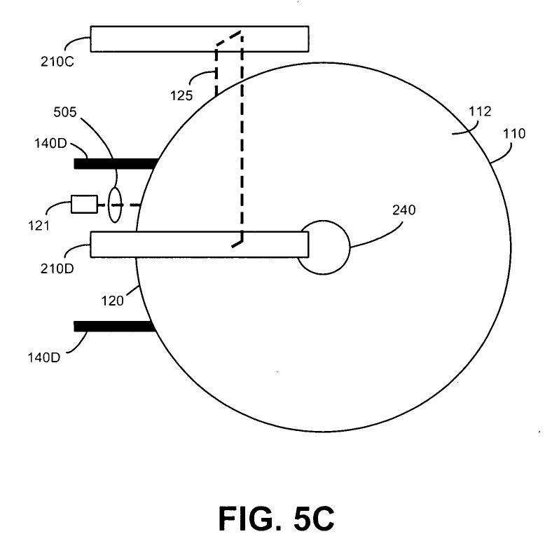

FIG. 5A is an axial view from first side 111, FIG. 5B is a side view, and FIG. 5C is an axial view from second side 112, of a fourth exemplary data storage device 100 according to an embodiment of the invention.

Reflectors 210B, 210C, 210D may be statically positioned so as to enable the use of an optical beam 125 to write to (or read from) both the first side 111 and the second side 112 of disk 110, as more fully described with respect to FIG. 2A and FIG. 2B.

A beam source 121, such as a laser for generating the beam 125, may in some embodiments be included in the OPU 120, and in some embodiments may be separated from the OPU 120. Further embodiments may include two beam sources 121, one of which is included in the OPU 120.

As shown in FIG. 5A, a beam source 121 separated from the OPU 120 may be fixed and pointing in a direction that is substantially along the surface of the first side 111 and substantially along the axis of motion of the sled 140A. In some embodiments, the beam source 121 may be mounted on a framework or case supporting or enclosing drive 110; in other embodiments, the beam source 121 may be mounted on the sled 140A. A collimating lens 505 is also mounted, proximate to the beam source 121, so as to receive and collimate the beam 125 emitted from the beam source 121.

In some embodiments, the OPU 120 comprises two focusing lenses 230, 231. A first focusing lens 231 (as shown in FIG. 5B) has a focal length suitable for focusing the beam 125 on the first side 111; that is, a relatively short focal length. A second focusing lens 230 (as shown in FIG. 5A and FIG. 5B) has a relatively long focal length suitable for focusing the beam 125 on the second side 112. For labeling applications on the second side 112, the second side 112 is able to tolerate a longer focal length of the beam 125, and the consequent larger spot size that comes with the longer focal length.

In some embodiments, an exemplary OPU 120 may comprise a steering mechanism 410 including a reflector 210A. The steering mechanism 410 is able to use the reflector 210A to steer the beam 125 in at least two directions. For example, reflector 210A may be a movable mirror positionable by the steering mechanism 410 (which may, for example, include one or more solenoids, galvanometers, or the like, and may be controlled by controller 150). The steering mechanism is able to position the reflector 210A to reflect the beam in a first direction for directing the beam 125 to the first side 111, or in a second direction for directing the beam 125 to the second side 112. The reflector 210A is able to reflect the beam 125 in the first direction, substantially toward the first side 111 of the disk 110, such that the beam 125 passes through focusing lens 231. The reflector 210A is also able to reflect the beam 125 in the second direction, substantially along the first side 111, such that the beam 125 passes through focusing lens 230 and impinges on reflector 210B.

In an alternate embodiment, the reflector 210A is able to reflect the beam 125 only in the second direction. In this alternate embodiment, the OPU 120 includes a second beam source 121A configured to emit a second beam (not shown) directed in the first direction, substantially toward the first side 111 of the disk 110, such that the beam 125 passes through the first focusing lens 231 having a short focal length suitable for focusing the beam 125 on the first side 111. This alternate embodiment thus has two sources for beam 125: the first beam source 121 emits a beam 125 that may be directed to strike the second side 112, and the second beam source 121A in OPU 120 emits a beam 125 that may be directed to strike the first side 111.

As shown in FIG. 5A, when the second side 112 is to be written or read, reflector 210A directs the optical beam 125 received from beam source 121 substantially along the first side 111 of the disk 110, to impinge on reflector 210B beyond the edge of the disk 110.

FIG. 5B illustrates that reflector 210B is mounted such that reflector 210B directs the beam 125 around the edge of disk 110, to reflector 210C. A bar reflector may be used for reflector 210B so that as the sled 140A moves the OPU 120 substantially radially with respect to the disk 110, the beam 125 will still impinge on the reflector 210B and be routed around the edge of disk 110. Once the beam 125 has reached a height above the surface of second side 112 of the disk 110, the beam 125 may impinge on another bar reflector 210C, which routes the beam 125 across the surface of the second side 112.

FIG. 5C illustrates that the path of beam 125 continues above the surface of second side 112 substantially alongside the path of outgoing beam 125 between reflectors 210A and 210B, but on the opposite side of the disk 110. The beam 125 then may impinge on another bar reflector 210D that directs the beam 125 substantially toward the surface of the second side 112, and thereafter the beam 125 strikes the surface of the second side 112.

Exemplary Embodiments Having Pivoting Arm

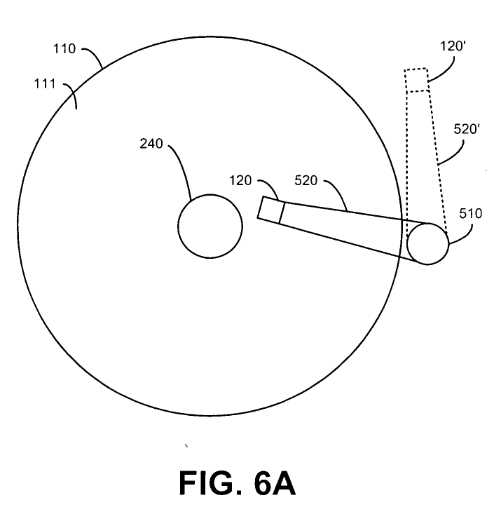

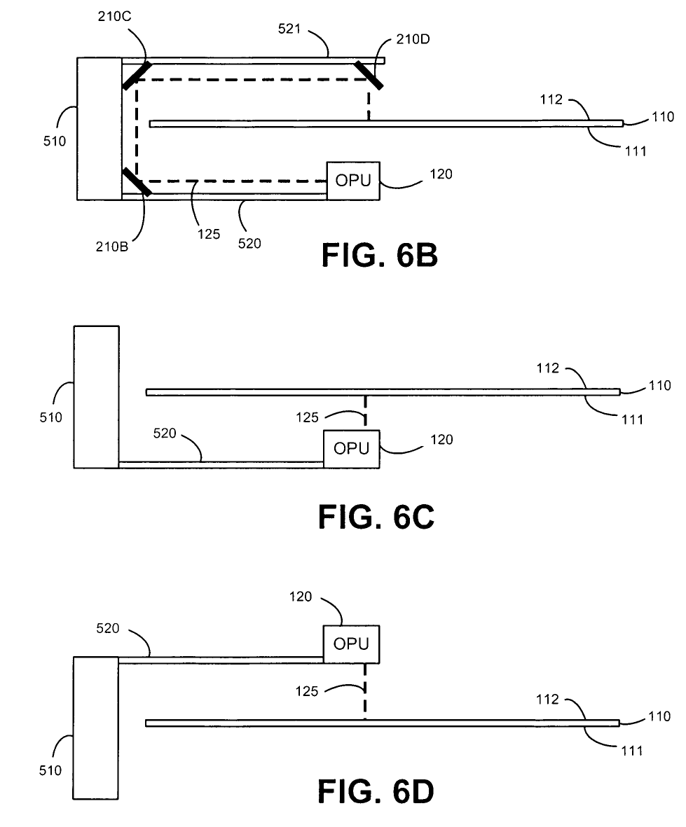

FIG. 6A is an axial view of a further exemplary data storage device 100 according to an embodiment of the invention, looking upon the first side 111 of the disk 110. The spindle motor mechanism 130 is able to rotate the disk 110 around an axis substantially central to the hub 240. A pivoting mechanism 510 situated beyond the edge of disk 100 is able to cause an arm 520 to pivot around an axis substantially alongside the axis around which disk 110 rotates. The pivoting mechanism 510 may be controlled by controller 150. A pivot end of the arm 520 is attached to pivoting mechanism 510, and OPU 120 may be situated at an opposite end of the arm distal to the pivoting mechanism 510.

In some embodiments, the pivoting mechanism 510 is also able to move the arm 520 substantially alongside the rotational axis of the pivoting mechanism 510 (e.g., raising and lowering the arm 520) to position the arm on either side of disk 110. In the drawing, dotted lines illustrate a second position of OPU 120 and arm 520, shown as OPU 120′ and arm 520′, in which the arm 520 has been rotated to a position clear of the disk 110, such that the arm 520 may be moved in an axial direction from one side of disk 110 to the other side without touching the disk 110.

FIG. 6B is a side view of an exemplary data storage device 100 according to a further embodiment of the invention having two arms 520, 521. A first arm 520 is situated adjacent to the first side 111 of the disk 110, and the second arm 521 is situated adjacent to the second side 112 of the disk 110. Reflector 210B and OPU 120 are positioned on the first arm 520. Reflectors 210C and 210D are positioned on the second arm 521. The second arm 521 tracks the position of the first arm 520 on the opposite side of disk 110. The reflectors 210 are positioned on the arms 520 so as to enable the use of a single optical beam 125 to write to (or read from) both the first side 111 and the second side 112 of disk 110, as previously described.

In the exemplary embodiment of FIG. 6B, reflectors 210B, 210C, 210D generally are not the long bar reflectors typically shown in FIG. 2B, but rather are generally smaller and shorter in length than a bar reflector, such that reflectors 210B, 210C, 210D may be readily maneuvered within the available space by the arms 520, 521 upon which reflectors 210B, 210C, 210D are mounted.

In this embodiment, OPU 120 includes an objective lens 230 and a beam source (such as a laser) for generating beam 125. The OPU 120 also includes a steering mechanism, not shown, which may comprise optics or mechanics for allowing the controller 150 to select a direction of the beam 125. For example, the beam 125 may be directed either substantially toward the first side 111, or substantially toward the reflector 210B so that a substantially collimated beam 125 is routed around the disk 110 to reflectors 210C and 210D, and thence to the surface of the second side 112.

FIG. 6C and FIG. 6D are side views of an exemplary data storage device 100 according to a still further embodiment of the invention. In the exemplary embodiment shown, the arm 520 may be may be moved from one side of disk 110 to the other side, as described with respect to FIG. 6A above.

In the exemplary embodiment of FIG. 6C and FIG. 6D, OPU 120 includes an objective lens 230 and a beam source (such as a laser) for generating beam 125, together with optics or mechanics for allowing the controller 150 to select a direction of the beam 125. The beam 125 may be directed in either axial direction (e.g., upward or downward). Thus, when the arm 520 is positioned adjacent to the first side 111 of the disk 110, as shown in FIG. 6C, the beam may be directed substantially toward the first side 111. Similarly, when the arm 520 is positioned adjacent to the second side 112 of the disk 110, as shown in FIG. 6D, the beam may be directed substantially toward the second side 112.

Exemplary Methods

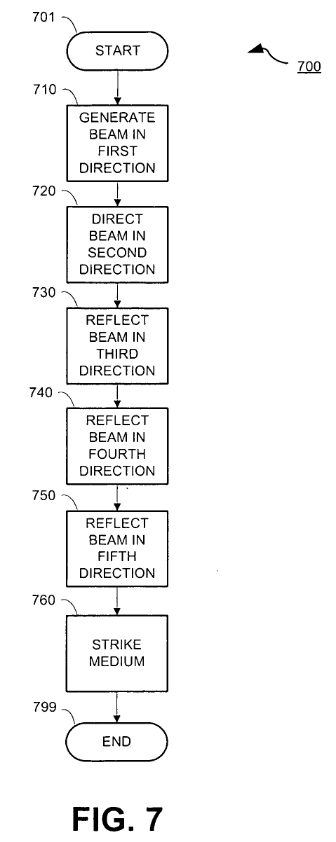

FIG. 7 shows a method 700 for writing on a double-sided medium, such as disk 110, according to an embodiment of the invention. A device 100 may perform the method 700 in one embodiment of the invention.

The method 700 begins at block 701. At block 710, a light beam 125 is generated in a first direction relative to a first side 111 of the disk 110. In some embodiments, the first direction is substantially toward the first side 111. In other embodiments, such as the fourth embodiment illustrated in FIG. 5A, FIG. 5B, and FIG. 5C, the first direction is substantially along the first side 111.

At block 720, the light beam 125 is directed in a second direction substantially along the first side 111, such that the light beam 125 is configured to impinge on a first reflector 210B.

At block 730, the light beam 125 is reflected in a third direction, such that the light beam 125 is routed outside a substantially opaque annulus 250 of the disk 110. In some embodiments, the beam 125 is routed outside an outer circumference of the disk 110, distal to the hub 240. However, the term “outside” does not require a radial distance larger than the radius of the disk 100, just one that does not coincide with the substantially opaque annulus 250. For example, in further embodiments, the beam 125 may be routed outside the substantially opaque annulus 250 by routing the beam 125 through the hub 240 or through a non-opaque annulus 245 encircling the hub 240.

At block 740, the light beam 125 is reflected in a fourth direction substantially opposite the second direction. At block 750, the light beam 125 is reflected in a fifth direction substantially toward the second side 112 of the disk 110. The second side 112 is opposite the first side 111. At block 760, the light beam 125 strikes a second side 112 of the disk 110 opposite the first side 111. The method concludes at block 799.

### CONCLUSION

Although exemplary implementations of the invention have been described in detail above, it will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An optical system for writing on a double-sided medium, comprising:
a beam source configured to generate a light beam in a first direction relative to a first side of the medium,
a steering mechanism able to direct the light beam in a second direction substantially along the first side, such that the light beam is configured to impinge on a first reflector,
the first reflector able to reflect the light beam in a third direction, such that the light beam is routed outside a substantially opaque annulus of the medium, and is configured to impinge on a second reflector,
the second reflector able to reflect the light beam in a fourth direction substantially opposite the second direction, such that the light beam is configured to impinge on a third reflector, and
the third reflector able to reflect the light beam in a fifth direction substantially toward a second side of the medium opposite the first side, such that the light beam strikes the second side of the medium.

2. The system of claim 1 wherein the first, third, and fifth directions are substantially parallel to a rotational axis of the medium, and the second and fourth directions are substantially perpendicular to the rotational axis.

3. The system of claim 1 wherein the first, second, and third reflectors are bar reflectors.

4. The system of claim 1 wherein the first, second, and third reflectors are fixed with respect to a rotational axis of the medium.

5. The system of claim 1 wherein an optical unit comprises the beam source, and the first direction is substantially toward the first side of the medium.

6. The system of claim 5 wherein the steering mechanism engages a fourth reflector, the steering mechanism being able to position the fourth reflector into a first position between the optical unit and the first side, such that the fourth reflector is configured to direct the light beam in the second direction to impinge on the first reflector.

7. The system of claim 6 wherein the fourth reflector is rotatable around an axis of the steering mechanism substantially alongside a rotational axis of the medium.

8. The system of claim 6 wherein the fourth reflector is positionable in a plane substantially along the first side.

9. The system of claim 6 wherein the steering mechanism engages a lens, the steering mechanism being able to position the lens into a first position between the optical unit and the first side, such that the objective lens is able to focus the light beam in the first direction onto the first side.

10. The system of claim 5 wherein the steering mechanism engages the optical unit, the steering mechanism being able to position the optical unit relative to a fourth reflector, such that the fourth reflector is able to direct the light beam in the second direction to impinge on the first reflector.

11. The system of claim 5 wherein the steering mechanism comprises a mechanism mover able to rotate the optical unit to a first position such that the light beam is emitted in the first direction, and to a second position such that the light beam is emitted in the second direction.

12. The system of claim 11 wherein the mechanism mover comprises a motor.

13. The system of claim 1 wherein the first direction is substantially toward the first side of the medium, further comprising:
a pivoting mechanism having a first arm and a second arm, the arms extending from the pivoting mechanism on opposite sides of the medium,
the first arm proximate to and substantially along the first side,
the second arm proximate to and substantially along the second side, and
the pivoting mechanism able to pivot the first and second arms around a pivoting axis outside a circumference of the medium and substantially along a rotational axis of the medium.

14. The system of claim 13 wherein an optical unit comprising the beam source is situated on the first arm distal from the pivoting axis,
the first reflector is situated on the first arm proximate to the pivoting axis,
the second reflector is situated on the second arm proximate to the pivoting axis, and
the third reflector is situated on the second arm distal to the pivoting axis.

15. The system of claim 13 wherein the second arm is substantially parallel to the first arm.

16. The system of claim 1 wherein the light beam striking the second side of the medium has a focal length of at least a diameter of the medium.

17. The system of claim 16 wherein the light beam striking the second side of the medium has a focal length of approximately a diameter of the medium.

18. The system of claim 16 wherein the first direction is such that the light beam is routed outside a circumference of the medium.

19. The system of claim 16 wherein the first direction is such that the light beam is routed through a non-opaque annulus of the medium.

20. The system of claim 1 wherein the first direction is such that the light beam is routed through a hub of the medium.

21. The system of claim 1 wherein the first direction is substantially along the first side of the medium, and the steering mechanism comprises a fourth reflector for directing the light beam in the second direction.

22. The system of claim 21 wherein the third and fifth directions are substantially parallel to a rotational axis of the medium, and the first, second and fourth directions are substantially perpendicular to the rotational axis.

23. The system of claim 21 wherein the steering mechanism is able to direct the light beam in the second direction and is able to direct the light beam in a sixth direction substantially toward the first side of the medium.

24. The system of claim 21 further comprising an optical unit having a second beam source for generating the light beam in a sixth direction substantially toward the first side of the medium.

25. The system of claim 1 further comprising a collimating lens between the beam source and the steering mechanism.

26. An optical system for writing on a double-sided medium, comprising:
an optical unit configured to generate a light beam in a first direction substantially along a rotational axis of the medium, the optical unit having a steering mechanism able to direct the light beam in a second direction opposite the first direction,
a pivoting mechanism having an arm extending substantially along the medium, the arm being rotatable around a pivoting axis outside a circumference of the medium and substantially alongside the rotational axis, the optical unit being situated on the arm distal from the pivoting axis,
the pivoting mechanism able to pivot the arm around the pivoting axis, and able to move the arm axially substantially along a length of the pivoting axis to a first axial position for directing the light beam to a first side of the medium and to a second axial position for directing the light beam to a second side of the medium.

27. A method for writing on a double-sided medium, comprising:
generating a light beam in a first direction relative to a first side of the medium,
directing the light beam in a second direction substantially along the first side, such that the light beam is configured to impinge on a first reflector,
reflecting the light beam in a third direction, such that the light beam is routed outside a substantially opaque annulus of the medium,
reflecting the light beam in a fourth direction substantially opposite the second direction,
reflecting the light beam in a fifth direction substantially toward a second side of the medium opposite the first side, and
striking the second side of the medium.

28. The method of claim 27 wherein the first, third, and fifth directions are substantially parallel to a rotational axis of the medium, and the second and fourth directions are substantially perpendicular to the rotational axis.

29. The method of claim 27 wherein the third and fifth directions are substantially parallel to a rotational axis of the medium, and the first, second and fourth directions are substantially perpendicular to the rotational axis.

30. The method of claim 27 further comprising:
positioning a fourth reflector into a first position between a beam source and the first side, such that the fourth reflector is configured to direct the light beam in the second direction to impinge on the first reflector.

31. The method of claim 30 further comprising rotating the fourth reflector around an axis of the steering mechanism substantially alongside a rotational axis of the medium.

32. The method of claim 30 further comprising positioning the fourth reflector in a plane substantially along the first side.

33. The method of claim 27 further comprising positioning a lens between a beam source and the first side.

34. The method of claim 33 further comprising focusing the light beam in the first direction onto the first side.

35. The method of claim 27 further comprising rotating an optical unit to a first position such that the light beam is emitted in the first direction, and
rotating the optical unit to a second position such that the light beam is emitted in the second direction.

36. The method of claim 27 further comprising pivoting a first arm and second arm around a pivoting axis outside the circumference of the medium and parallel to a rotational axis of the medium.

37. The method of claim 27 further comprising focusing the light beam onto the second side of the medium using a focal length of at least a diameter of the medium.

38. A method for writing on a double-sided medium, comprising:
generating a light beam in a first direction substantially along a rotational axis of the medium,
steering the light beam in a second direction opposite the first direction,
pivoting an arm around a pivoting axis outside the circumference of the medium and substantially alongside the rotational axis, the arm extending from a pivoting mechanism substantially along the medium and having an optical unit on the arm distal from the pivoting axis,
moving the arm axially substantially along a length of the pivoting axis to a first axial position,
directing the light beam to a first side of the medium,
moving the arm axially substantially along the length of the pivoting axis to a second axial position, and
directing the light beam to a second side of the medium.

39. An optical system for writing on a double-sided medium, comprising:
means for generating a light beam in a first direction relative to a first side of the medium,
means for directing the light beam in a second direction substantially along the first side,
first means for reflecting the light beam received from the means for directing, such that the light beam is routed outside a substantially opaque annulus of the medium,
second means for reflecting the light beam received from the first means for reflecting, in a third direction substantially opposite the second direction, and
third means for reflecting the light beam received from the second means for reflecting, in a fourth direction, such that the light beam strikes a second side of the medium opposite the first side.
